(19) United States
(12) Patent Application Publication
(10) Pub. No.: US 2002/0101788 A1
(43) Pub. Date: Aug. 1, 2002

(54) Watch having an improved articulating mechanism

(76) Inventor: Kevin Petsch, Reading, PA (US)

Correspondence Address: Bruce J. Wolstoncroft, Esquire, Barley, Snyder, Senft & Cohen, LLC, 126 East King Street, Lancaster, PA, 17602, US

(21) Appl. No.: 09/773,834

(22) Filed: Feb. 1, 2001

(51) Int. Cl. A44C 5/00; G04B 37/00

(52) U.S. Cl. 368/281

(57) ABSTRACT

A portable watch and band is provided which is capable of being worn on various parts of the body and secured to other objects. The watch and band assembly has an articulated folding mechanism wherein the watch forms an element of the folding mechanism. The band is removable from the folding mechanism and is expandable. Both the folding mechanism and the expandable band serve to fix the assembly around various sizes of body parts or other objects.

### FIELD OF THE INVENTION

The present invention relates to watches and other portable watches and more particularly to an improved articulating band mechanism for use in such watches.

### BACKGROUND

Tri-part articulated watch bands are known in the art. Such a band is shown in U.S. Pat. No. 4,000,542 as having three elements which are pivotally connected to each other so that in a closed position they fold over each other in zig zag pattern to draw the watch band closed. The clasp is typically provided on one of the elements and locks with the catch on the element is folded onto.

An improvement to the basic tri-part articulated watch band is shown in U.S. Pat. No. 4,748,604 wherein the first part of the device is shaped to receive and partially protect the watch. The first part is formed of two parts that rotate and fold over each other. The third part also folds over the first two and is disposed beneath the first two so that the articulated device cannot be seen as it is hidden behind watch body.

It is desirable to produce a portable watch which is capable of being secured to various parts of the body such as hands, fingers, or wrists and around other tubular components such as handle bars, steering wheels, or other assemblies. A problem exists with the known tri-part watch bands in that they are not adjustable for large variations in band size and they are not typically separable to allow installation on other components. For example, such wrist bands are not easily adaptable for wearing on hands or fingers. Also, such wrist bands are not separable to allow installation around other closed components such as a steering wheel or tubular constructions on a bike or motorcycle.

### SUMMARY

It is therefore an object of the invention to provide a portable watch and band which is capable of being worn on various parts of the body and secured to other objects. This and other objects of the invention are achieved by providing a watch and band assembly having an articulated folding mechanism wherein the watch forms an element of the folding mechanism. The band is removable from the folding mechanism and is expandable. Both the folding mechanism and the expandable band serve to fix the assembly around various sizes of body parts or other objects.

### BRIEF DESCRIPTION OF THE DRAWINGS

The invention will now be described by way of example with reference to the accompanying figures of which:

FIG. 1 shows a perspective view of a watch according to the invention.

FIG. 2 shows a perspective view of the watch of FIG. 1 in an open position.

FIG. 3 shows a cross-sectional view taken along the line 3-3 of FIG. 1.

FIG. 4 shows a cross-sectional view similar to that of FIG. 3 having the folding mechanism in a partially open position.

FIG. 5 shows a cross-sectional view similar to that of FIG. 4 having the folding mechanism in an open position.

FIG. 6 shows a cross-sectional view of a first alternate embodiment wherein the folding mechanism is disengaged from the watch.

FIG. 7 shows a cross-sectional view of a second alternate embodiment wherein the folding mechanism is disengaged.

FIG. 8 shows a cross-sectional view of the third alternate embodiment wherein the folding mechanism is disengaged from the band.

FIG. 9 shows a cross-sectional view taken along the line 9-9 of FIG. 7.

FIG. 10 is a cross-sectional view taken along the line 10-10 of FIG. 8

FIG. 11 shows a perspective view of fourth alternate embodiment in which the folding mechanism contains openings for the watch face.

FIG. 12 shows a perspective view of the fourth alternate embodiment in an open position.

FIG. 13 shows a cross-sectional view taken along the line 13-13 of FIG. 11.

FIG. 14 shows a cross-sectional view similar to that of FIG. 13 having the folding mechanism in a partially open position.

FIG. 16 shows a fifth alternate embodiment wherein the watch is temporarily fixed to the band beneath the watch face.

### DETAILED DESCRIPTION OF THE PREFERRED EMBODIMENTS

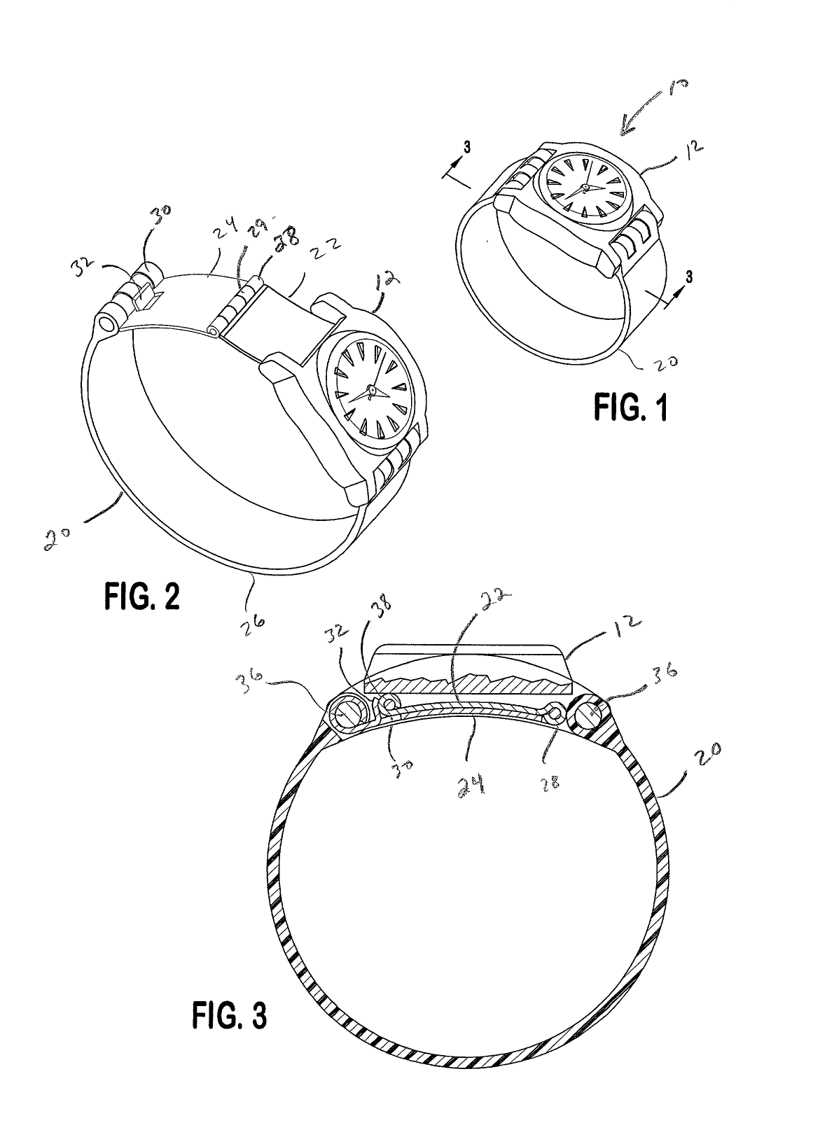

The watch 10 according to the present invention will now be described generally with reference to FIG. 1. The watch 10 consists of two major components. A face 12 is connected to a band 20 at two locations to form the watch 10. The face 12 includes a watch mechanism and a housing. The face 12 may include any type of watch mechanism such as the digital or analog mechanism. Referring to FIG. 2,8 can be seen that the band 20 consists of three major sections which form an articulating mechanism. The first leg 22 is connected to the face 12 by a pin 36 (FIG. 3). The first leg 22 has a pin receiving barrel 38 at a first end and a hinge portion 29 formed at a second end. The second leg 24 extends from the first leg 21 and has hinge portion's 28, 30 formed at both ends. A catch 32 extends outward from the second leg near a hinge portion 30. A strap 26 connects one end of the face 12 with the second leg 24. To strap 26 may be formed of either a solid or flexible material and is preferably flexible and expandable to allow a tight fit around various size body parts or other objects. For example, the watch 10 may be fixed around a thumb, other fingers, a wrist, or handle bars of a bicycle or motorcycle. The strap 26 is connected to the face 12 by a pin 36 passing through an opening in the strap 26 as best shown in FIG. 3.

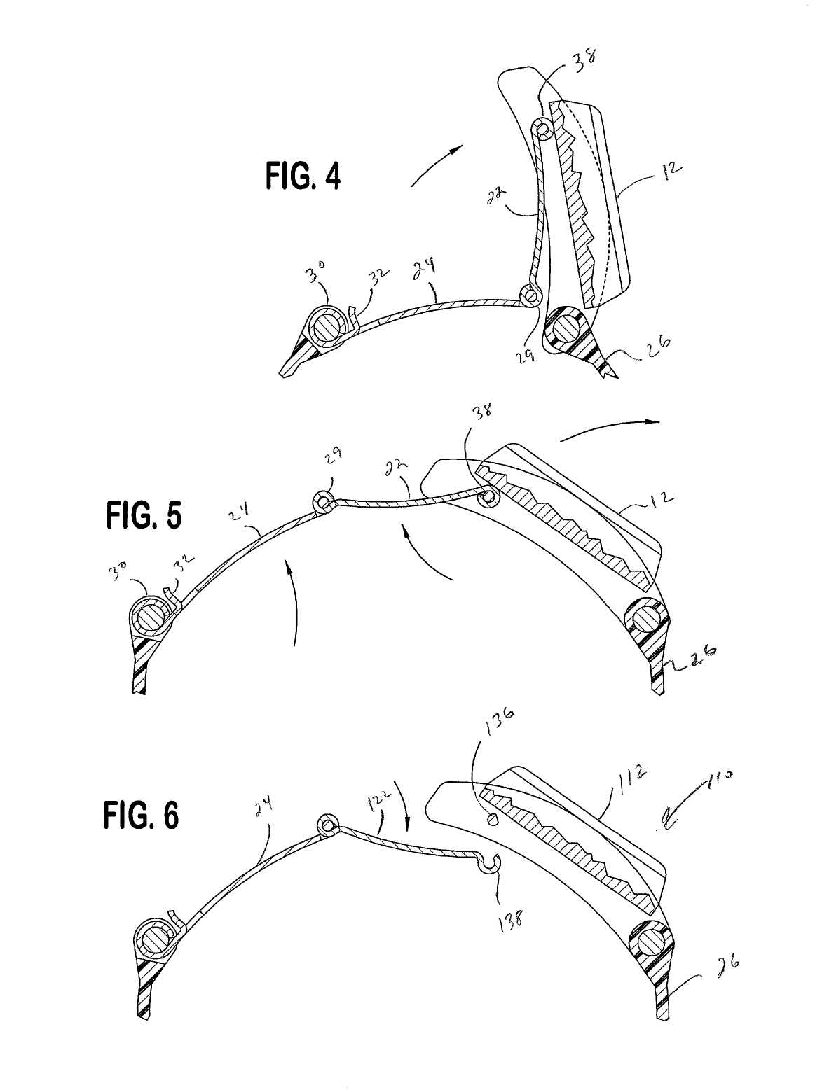

Operation of the watch 10 and band 20 assembly will now be described in greater detail with reference to FIGS. 4 an 5. Referring first to FIG. 5, the assembly is shown in the fully open position wherein both the first and second legs 22,24 are fully extended and urged into this open position as indicated by the arrows in FIG. 5. To close the assembly, the first leg 22 is first rotated toward the face 12 as shown in FIG. 4. The second leg 24 is then rotated toward the first leg 22. It should be noted here that the underside of the face 12, the first leg 22, and the second leg 24 are contoured to fit over each other. The second leg 24 is further rotated until the catch 32 engages the pin receiving barrel 38 of the first leg 22. Once the catch 32 engages the pin receiving barrel 38, the assembly is secured in the fully closed position as shown in FIG. 3. It should be noted that both legs 22,24 are fully concealed in this position.

The first alternate embodiment 110 will now be described with reference to FIG. 6. In this embodiment, the interface between the first leg 122 and the face 112 has a slightly different configuration. The second leg 24 and the strap 26 are the same as the first embodiment shown in FIGS. 1-4. The first leg 122, however, is modified to have a hook 138 in place of the pin receiving barrel 38. The hook 138 is profiled to engage the hook engaging member 136 formed on the underside of the face 112. The hook engaging member 136 is preferably formed as a rod extending between ends of the face 112. The hook engaging member 136 may alternatively be a projection or recess which is complementary to and receives the hook 138. This arrangement allows for the alternate watch 110 to be removed from a solid object by disengagement of the hook 138 from the hook engaging member 136. Also, recall that the strap 26 may be expandable to allow a tight fit over various size body parts or objects. This embodiment is especially useful for securing the alternate watch 110 to handle bars of a bicycle or motorcycle.

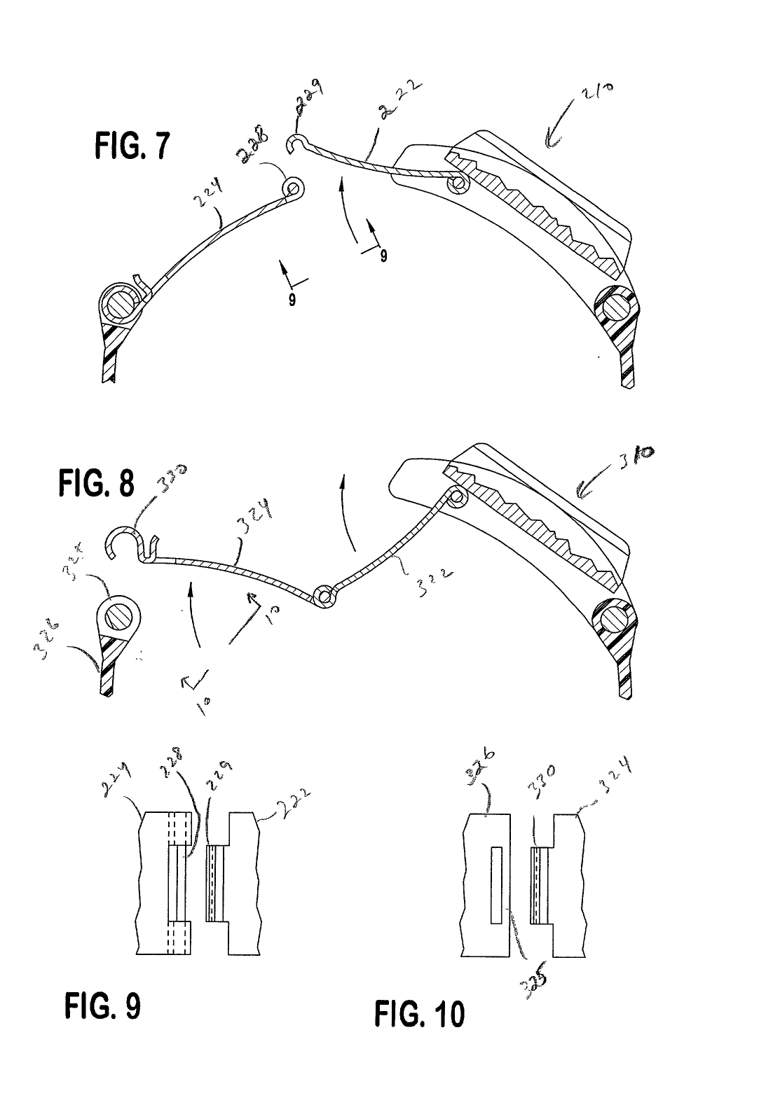

FIG. 7 shows a second alternate embodiment 210 in which the hinge portion 29 of the first embodiment is replaced with the hook 229. Here, the same functionality as shown in FIG. 6 is achieved however the disengagement point is moved from one end of the first leg 222 to the opposite end. FIG. 9 shows a cross-sectional view of the hook 229 and the hook engaging portion 228 of the second leg 224. These parts engage similar to those described with reference to FIG. 6.

FIG. 8 shows a third alternate embodiment 310 in which the hinge portion 30 of the second leg 24 is replaced by a hook 330. The hook 330 engages a hook engaging portion 325 on the strap 326. Disengagement allow separation of the second leg 324 from the strap 326. The engagement and disengagement of these parts is similar to that described with reference to FIG. 6. FIG. 10 shows in further detail the hook 330 and the hook engaging section 325.

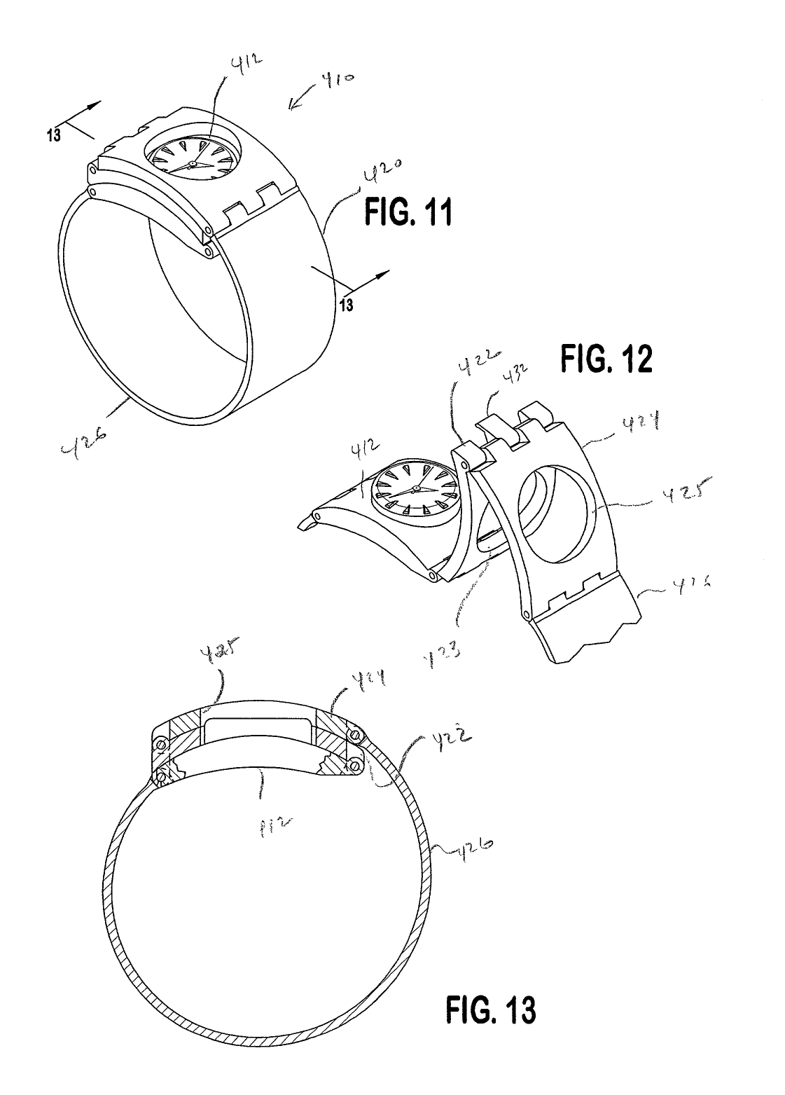

FIGS. 11-15 show a fourth alternate embodiment 410 in which the first and second legs 422,424 fold over the top surface of the face 412 instead of being concealed on the underside of the face 12 as was shown in the embodiment of FIG. 1. The first leg 422 is contoured to match the upper surface of the face 412. An opening 423 is formed in the first leg 422. The opening 423 is shaped to receive a portion of the face 412. The first leg 422 is hinged at both ends wherein a first end is hinged to the face 412 while a second end is hinged to the second leg 424 forming an articulating mechanism. Proximate the hinge connecting to the second leg 424, a catch 432 extends toward the face 412. The second leg 424 is similarly contoured to fit over the first leg 422 and has an opening 425 formed therein. The opening 425 is formed to be in alignment with the opening 423 when the legs are in a closed position as shown best in FIGS. 11 and 13. This articulating mechanism is similarly opened and closed as the one described in the previous embodiments of FIGS. 4 an 5.

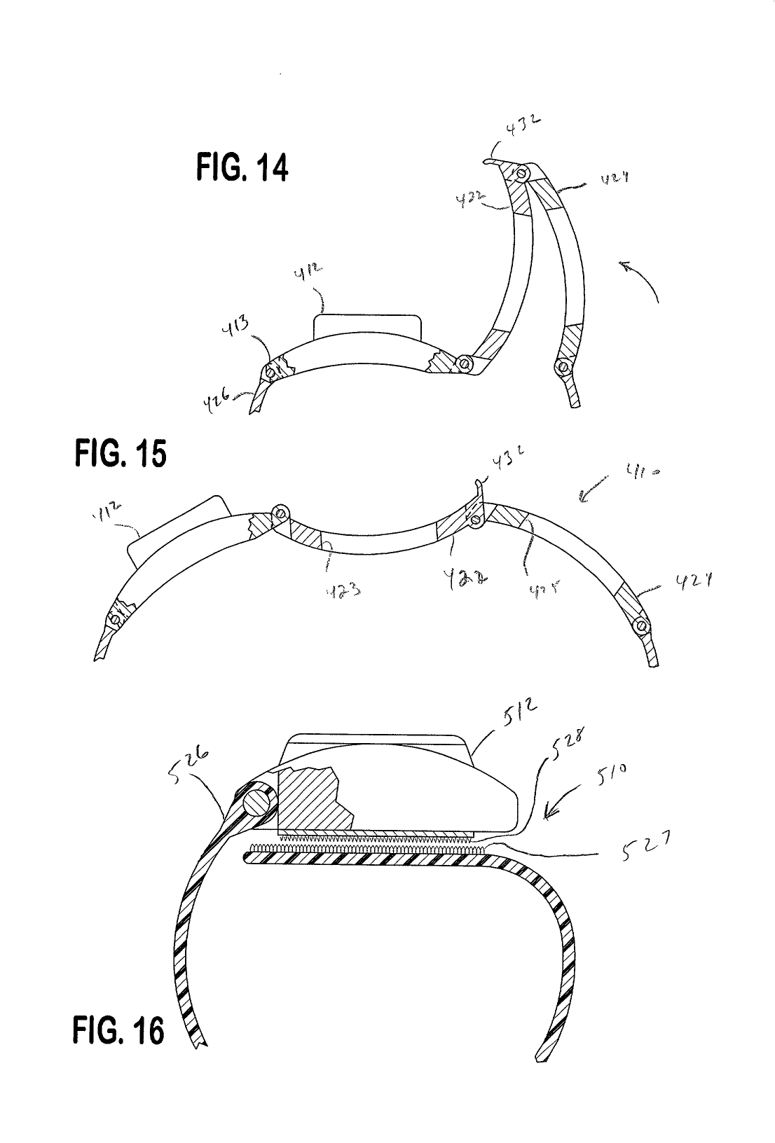

Referring now to FIGS. 14 and 15 opening and closing the articulating mechanism will be described in greater detail. FIG. 15 shows the watch 410 in a fully open position wherein the legs 422,424 and the face 412 are fully extended. As the second leg 424 is occurs in the direction of the arrow shown in FIG. 14, the articulating the mechanism begins to close. The second leg 424 first contacts the first leg 422 and then both are urged further toward the face 412 until the catch 432 engages the engaging member 413 on the face 412 to secure the assembly in a closed position as best shown in FIG. 13.

A fifth alternate embodiment 510 is shown in FIG. 16. In this embodiment, the watch 510 has a face 512 secured to a strap 526 at a first end. The opposite end of the strap 526 has a fastening material 527 disposed on its surface. This fastening material may be VELCRO or other suitable tacky material. Similarly, complementary fastening material 528 is position on the underside of the face 512. The strap 526 may be flexible or rigid depending upon the application and is removable from the face 512 at the fastening material interface 527, 528. It should be understood by those reasonably skilled in the art that this fastening feature could be combined with the articulating mechanisms of the other embodiments. For example VELCRO could be used in place of a catch shown in the previously described embodiments

An advantage of the present invention is that a portable watch is provided for use on various size objects and body parts such as a thumb, fingers, the wrist, handle bars, or other devices. This is made possible because the strap is made to be flexible to adapt to various size members and in some embodiments, the strap is removable from the face to allow the watch to be easily removed from a closed member.

I claim:

1. A watch and band assembly comprising:
a watch face;
a first leg having first and second ends and being hinged to the watch face at the first end;
a second leg having first and second ends and being hinged to the first leg at a junction formed by the second end of the first leg and the first end of the second leg; and,
a strap extending from the second end of the second leg to the watch face.

2. The watch and band assembly of claim 1 wherein the second leg further comprises a catch extending therefrom to engage the first end of the first leg when the assembly is in a closed position.

3. The watch and band assembly of claim 2 wherein both the first and second legs are concealed under the watch face when the assembly is in a closed position.

4. The watch and band assembly of claim 3 wherein the first leg is disengagable from the watch face.

5. The watch and band assembly of claim 4 wherein the first leg further comprises a hook disposed at the first end thereof.

6. The watch and band assembly of claim 5 wherein the watch face further comprises a hook engaging member for receiving the hook.

7. The watch and band assembly of claim 3 wherein the first leg is disengagable from the second leg.

8. The watch and band assembly of claim 7 wherein the first leg further comprises a hook disposed at the second end thereof.

9. The watch and band assembly of claim 8 wherein the second leg further comprises a hook engaging member for receiving the hook.

10. The watch and band assembly of claim 3 wherein the second leg is disengagable from the strap.

11. The watch and band assembly of claim 10 wherein the second leg further comprises a hook disposed at the second end thereof.

12. The watch and band assembly of claim 11 wherein the strap further comprises a hook engaging member for receiving the hook.

13. The watch and band assembly of claim 1 wherein the strap is expandable.

14. The watch and band assembly of claim 13 wherein the strap is fastened to the watch face by VELCRO.

15. The watch and band assembly of claim 1 wherein the first and second legs are articulated over a top surface of the watch face to a closed position.

16. The watch and band assembly of claim 15 wherein the watch face is shown through openings formed in the first and second legs.

17. The watch and band assembly of claim 16 further comprising a catch disposed at the first end of the second leg for engaging the top surface of the watch face in the closed position.
